(19) United States
(12) Patent Application Publication
(10) Pub. No.: US 2025/0213326 A1
(43) Pub. Date: Jul. 3, 2025

(54) Endodontic File System with Automatic Distance Measurement Circuit

(71) Applicants: Frederick Micah Nuzum, Wooster, OH (US); John P. Cichello, Wooster, OH (US)

(72) Inventors: Frederick Micah Nuzum, Wooster, OH (US); John P. Cichello, Wooster, OH (US)

(21) Appl. No.: 18/851,827

(22) PCT Filed: Mar. 29, 2023
(86) PCT No.: PCT/US2023/016768

§ 371 Date: Sep. 27, 2024

Related U.S. Application Data
(60) Provisional application No. 63/325,416, filed on Mar. 30, 2022.

(51) Int. Cl. A61C 5/44; A61C 5/42; A61C 19/04

(52) U.S. Cl. CPC A61C 5/44; A61C 5/42; A61C 19/041

(57) ABSTRACT

A working length measuring endodontic file system (10) comprises an endodontic file (11) having a stopper (22) moveable along a shaft (12), and a distance measurement circuit (24) which automatically determines a distance from the handle (20) to the stopper (22). The endodontic working length is then determined by subtracting this distance and the thickness of the stopper (22) from the length of the shaft (12). The handle-to-stopper distance may be measured using any known approach, such radiated signal rangefinding (e.g., laser, lidar, radar, or ultrasonic); inductive distance sensing; linear magnetic encoding; mechanical linkage coupled to, e.g., rheostat or measuring wheel encoder; resistance measurement; and the like. In one aspect, a camera (25) and image recognition software calculate the handle-to-stopper distance.

### RELATED APPLICATIONS

This application claims priority to U.S. Application No. 63/325,416, filed 30 Mar. 2022, disclosure of which is incorporated in its entirety by reference herein.

### FIELD OF DISCLOSURE

The present disclosure relates generally to endodontic treatments, and in particular to an endodontic file system including an endodontic file and a distance measuring circuit that automatically measures a distance between a handle and stopper of the file, from which the endodontic working length is calculated.

### BACKGROUND

Endodontic treatment-commonly known as root canal treatment—is a process of removing injured, inflamed, infected, or dead pulp from a tooth, disinfecting the tooth and treating it with antibiotics to remove any infection, and replacing the pulp with a sealant. Pulp is the soft material in the center of a tooth, beneath a hard, porous layer called the dentin, which in turn is surrounded by an enamel outer covering. The pulp consists of nerves, connective tissue, and blood vessels. The pulp may be damaged in a variety of ways, including decay due to an untreated cavity, chip, or crack in the tooth, contact injury to the tooth (even if the enamel is not cracked), or multiple dental procedures performed on the same tooth. Conditions that call for an endodontic treatment can include pulpal necrosis (death of the pulp), apical periodontitis (inflammation of the surrounding tissue at tip, or apex, of the tooth's root), and dental abscess (collection of puss inside the tooth).

When the pulp is so damaged or infected that a dentist determines it must be removed, an endodontist, dentist, or qualified technician performs an endodontic treatment procedure. For simplicity and consistency, this person is referred to herein as a clinician. The endodontic treatment begins much like a routine filling—the patient's gum is anesthetized, and a small opening is drilled in the top of the affected tooth. The clinician uses a tool known as an endodontic file to remove the damaged or infected pulp, and clean the interior of the tooth and its root canal(s).

A critical parameter that must be ascertained for a successful endodontic treatment, known as the “working length,” is the distance from the top of the tooth to the depth within the root canal to which the applied sealant extends. This depth is typically approximately 0.5 mm short of the apical foramen (a natural opening at the apex, or tip, of the root), and may coincide with the apical constriction (a significant narrowing of the root canal). Research indicates that root canal fillings that fall more than 2 mm short of the apical foramen are associated with a high chance of endodontic failure.

In modern endodontics, the working length measurement is facilitated by use of an Electronic Apex Locator (EAL). The EAL monitors an electrical circuit formed between a first clip attached to an endodontic file positioned within the root canal of the tooth, and a second clip on patient's lip. Current flows down the shaft of the file, through the apical foramen, through the periodontal ligament (PDL, which is connective tissue surrounding the tooth in an alveolar socket), through the mucosa, and into the lip clip. The EAL monitors various properties of this electrical circuit (e.g., electrical inductance at one or more frequencies) as the clinician slowly lowers the endodontic file into the root canal. At the point at which the tip of the file reaches, e.g., the apical foramen, the monitored electrical properties exhibit significant variation, and the EAL issues a visual or audible indication. Some EALs emit an indication when the endodontic file reaches the apical constriction. In either case, upon the EAL indication, the clinician holds the file at this position, and lowers a stopper down the shaft of the file until it contacts the top of the tooth. The distance from the stopper to the tip of the file is the working length, which is typically determined by holding the endodontic file against a ruler and reading the ruler's scale. The clinician may adjust the indicated working length by, e.g., 0.5 mm, depending on whether the EAL triggers at an apical constriction or an apical foramen.

While modern EALs detect the position of the endodontic file at a predetermined point within the root canal (typically either the apical constriction or apical foramen) with great precision, this precision often is not carried forward to the ascertained value of the working length. The scale used to measure the distance from the stopper to the tip of the file may be difficult to read with accuracy. The file may not be positioned properly against the ruler to obtain an accurate reading. The stopper may slip from position when removed from the tooth, causing inaccurate measurements. Lighting conditions may not be ideal to read the scale with the greatest accuracy. Fatigue, a headache, or the like may adversely affect the clinician's ability to focus on the scale, or to read it accurately.

The Background section of this document is provided to place aspects of the present disclosure in technological and operational context, to assist those of skill in the art in understanding their scope and utility. Unless explicitly identified as such, no statement herein is admitted to be prior art merely by its inclusion in the Background section.

### SUMMARY

The following presents a simplified summary of the disclosure in order to provide a basic understanding to those of skill in the art. This summary is not an extensive overview of the disclosure and is not intended to identify key/critical elements of aspects of the disclosure or to delineate the scope of the disclosure. The sole purpose of this summary is to present some concepts disclosed herein in a simplified form as a prelude to the more detailed description that is presented later.

According to one or more aspects described and claimed herein, a working length measuring endodontic file system includes an endodontic file and a distance measurement circuit that automatically determines a distance between the handle and the stopper of the file. The working length is determined by subtracting this distance, and the width of the stopper, from the length of the file (i.e., the distance from the handle to the tip of the file). In some aspects, the distance measurement circuit is disposed in the handle, and the handle-to-stopper distance is measured using any of various means, such as radiated signal rangefinding (e.g., laser, lidar, radar, or ultrasonic); inductive distance sensing; capacitive encoding; mechanical linkage coupled to, e.g., a rheostat or encoding wheel; resistance measurement; and the like. In one aspect, a distance measurement circuit in the handle is powered by energy harvested from the endodontic file clip of an EAL. In one aspect, the handle includes a battery. In one aspect, the distance measurement circuit comprises a camera with a view of the endodontic file, and image recognition software.

In one aspect, a conventional EAL is used, with a working length module interposed between the EAL and the endodontic file clip and lip clip. The working length module operates in two modes, selected by the clinician, e.g., via a foot switch. A first mode is a “pass through” mode, wherein signals from/to the EAL are passed through to the endodontic file clip and lip clip, respectively. In a second mode, the EAL is disconnected, and distance data is passed to the working length module, directly or by using the endodontic file clip. The working length module displays or otherwise outputs the calculated working length value. In another aspect, the working length module is integrated with the EAL, which both alerts when the endodontic file tip reaches a predetermined location in the tooth (such as the apical foramen), and subsequently displays the working length, calculated from the measured distance between the handle and the stopper, the stopper thickness, and the file length.

One aspect relates to a working length measuring endodontic file system comprising an endodontic file and a distance measuring circuit. The file includes a generally cylindrical shaft, at least part of which tapers towards a tip; a handle connected to the shaft opposite the tip; and an annular stopper disposed around the shaft. The stopper is moveable at least part of the way between the handle and tip along a longitudinal axis of the shaft. The distance measuring circuit is configured to measure a distance between the handle and the stopper.

Another embodiment relates to a method of obtaining a working length for a tooth undergoing endodontic treatment, using a working length measuring endodontic file system comprising an endodontic file comprising a generally cylindrical shaft, at least part of which tapers towards a tip, a handle connected to the shaft opposite the tip, an annular stopper disposed around the shaft, and moveable at least part of the way between the handle and tip along a longitudinal axis of the shaft. The system also includes a distance measuring circuit configured to measure a distance between the handle and the stopper. The tip of the endodontic file is advanced into a root canal of the treated tooth. Advancement of the endodontic file is halted when an Electronic Apex Locator (EAL) attached to the file indicates that the tip of the file has reached a predetermined point within the root canal of the treated tooth. The endodontic file is held at the halted location, and a stopper is slid over a shaft of the file until it contacts a top of the treated tooth. A working length of the treated tooth calculated from an automatic distance measurement by the distance measuring circuit is read.

### BRIEF DESCRIPTION OF THE DRAWINGS

The present disclosure will now be described more fully hereinafter with reference to the accompanying drawings, in which aspects of the disclosure are shown. However, this disclosure should not be construed as limited to the aspects set forth herein. Rather, these aspects are provided so that this disclosure will be thorough and complete, and will fully convey the scope of the disclosure to those skilled in the art. Like numbers refer to like elements throughout.

FIG. 1 is a diagram of an endodontic file system.

FIG. 2 is a block diagram of an endodontic control unit and endodontic file system.

FIG. 3 is a block diagram of an EAL, working length measurement unit, and endodontic file system.

FIG. 4 is a diagram of a distance measuring circuit using a rotary potentiometer or encoding wheel.

FIG. 5 is a diagram of a distance measuring circuit using a linear potentiometer or capacitive encoder.

FIGS. 6A and 6B are diagrams of a distance measuring circuit using the resistance of the endodontic file shaft.

FIG. 7 is a diagram of a distance measuring circuit using emitted radiation rangefinding.

FIG. 8 is a diagram of a distance measuring circuit using inductive sensing.

FIGS. 9A and 9B are diagrams of a distance measuring circuit using spaced conductive strips.

FIG. 10 is a block diagram of an endodontic control unit and endodontic file system using a camera.

FIG. 11 is a block diagram of an EAL, working length measurement unit, and endodontic file system using a camera.

FIG. 12 represents a view of an endodontic file captured by a camera, with object recognition bounding boxes generated by image recognition software.

FIG. 13 is a flow diagram of a method of obtaining a working length for a tooth undergoing endodontic treatment.

### DETAILED DESCRIPTION

For simplicity and illustrative purposes, the present disclosure is described by referring mainly to an exemplary aspect thereof. In the following description, numerous specific details are set forth in order to provide a thorough understanding of the present disclosure. However, it will be readily apparent to one of ordinary skill in the art that the present disclosure may be practiced without limitation to these specific details. In this description, well known methods and structures have not been described in detail so as not to unnecessarily obscure the present disclosure. For the purpose of explanation, aspects of the present disclosure are described herein in terms of websites. Those of skill in the art will readily appreciate that this term includes manifestations of online interaction such as social media, interactive forums, peer-to-peer networks, virtual environments, and the like.

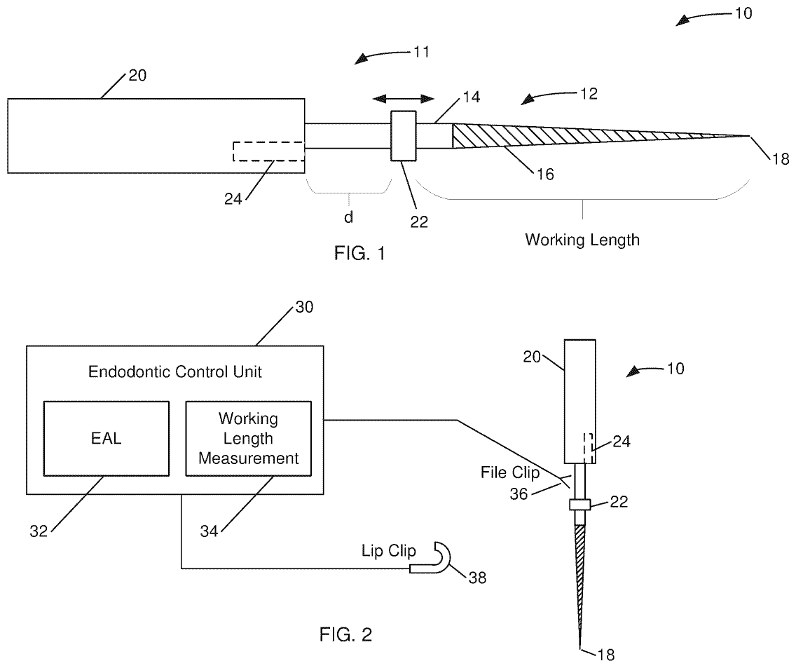

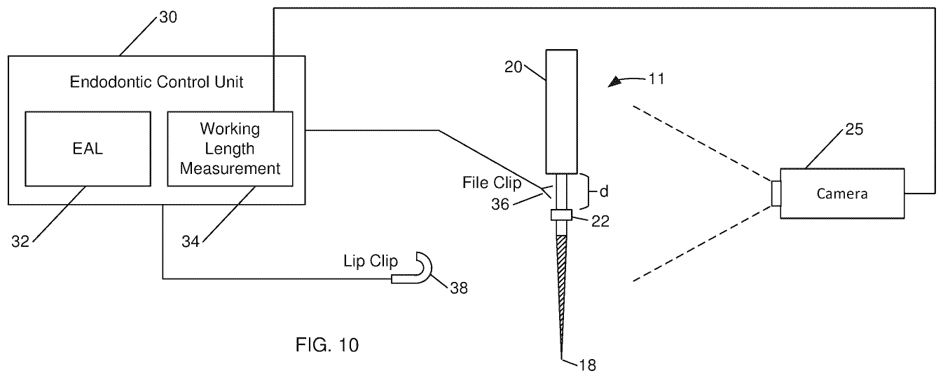

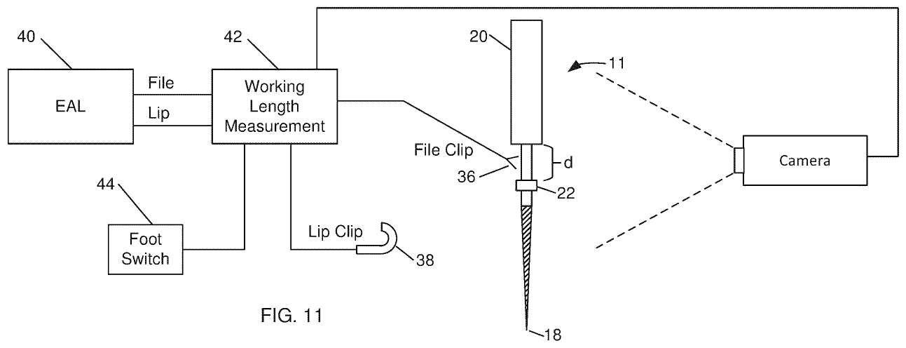

FIG. 1 depicts a working length measuring endodontic file system 10, according to some aspects of the present disclosure. The working length measuring endodontic file system 10 comprises an endodontic file 11 comprising a shaft 12, a handle 20, a stopper 22 moveable along a longitudinal axis of the shaft. The working length measuring endodontic file system 10 also comprises a distance measuring circuit 24. In the aspect depicted, the distance measuring circuit 24 is disposed in the handle 20 of the endodontic file 11. FIGS. 10 and 11 depict aspects of the working length measuring endodontic file system 10 in which the endodontic file 11 does not include the distance measuring circuit 24 in the handle 20, but rather the distance measuring circuit 24 comprises a camera 25 and image recognition software.

Returning to FIG. 1, the shaft 12 is generally cylindrical in shape. The shaft 12 may have a cylindrical portion 14 adjacent to the handle 20. At least part of the shaft 12 comprises a tapered portion 16, which tapers in cross-sectional area with increasing distance from the handle 20, ending in a tip 18. As indicated by the slanted lines, the tapered portion 16 may include groves, similar to a drill bit, or other patterns of metalwork. In some aspects, the tapered portion 16 may comprise the entire shaft 12, and there is no cylindrical portion 14. Endodontic files 11 are available in a variety of different sizes, with different tapers.

The handle 20 may be of any shape or size, and is preferably formed of metal or plastic, to facilitate sanitization. The handle 20 may have a textured surface, to aid in gripping.

An annular stopper 22 is disposed around the shaft 12. As indicated by the double-headed arrow, the stopper 22 is moveable at least part of the way between the handle 20 and the tip 18, along the longitudinal axis of the shaft. In use, when an EAL indicates that the tip 18 of the file 10 is located at a predetermined point of the tooth being treated (such as the apical foramen), the clinician slides the stopper 22 along the shaft 12, in a direction towards the tip 18, until the stopper 22 rests against the top of the tooth. This preserves the working length, defined as the distance between the end of the stopper 24 opposite the handle 20, and the tip 18, as indicated in FIG. 1.

According to some aspects of the present disclosure, a distance measuring circuit 24 may be disposed on, or preferably within, the handle 20. According to other aspects of the present disclosure, the distance measuring circuit 24 comprises a camera, together with image recognition software. In all aspects, the distance measuring circuit 24 is configured to measure the distance d between the handle 20 and the end of the stopper 22 closest to the handle 20. One can readily conclude from FIG. 1 that the working length is the length of the shaft 12, minus the sum of the distance d between the handle 20 and the stopper 22, and the width or thickness (in the longitudinal direction) of the stopper 22. Since the length of the shaft and width of the stopper 22 are known, and the distance measuring circuit 24 measures the distance d between the handle 20 and the stopper 22, calculation of the working length is straightforward. In particular,

$$wl = tl - d - st where \qquad ( 1 )$$

wl=working length
tl=total length of the shaft 12
d=automatically measured distance between the handle 20 and near end of the stopper 22
st=stopper thickness

In one aspect, the distance measuring circuit 24 calculates and outputs the working length—that is, it performs the above calculation, based on configured values of the length of the shaft 12 and width of the stopper 22. In another aspect, the distance measuring circuit 24 simply outputs the measured distance between the handle 20 and the stopper 22, with the working length being calculated externally, such as in a working length measurement circuit, as described herein.

In one aspect, a distance measuring circuit 24 disposed in the handle 20 is powered by energy harvested from the EAL endodontic file clip (not shown in FIG. 1). In another aspect, a distance measuring circuit 24 disposed in the handle 20 is powered by a battery (not shown) also disposed in the handle 20. In one aspect the distance measuring circuit 24 outputs one or both of the measured distance between the handle 20 and the stopper 22, and the working length, using the endodontic file clip. In another aspect, the distance measuring circuit 24 outputs one or both of the measured distance between the handle 20 and the stopper 22, and the working length, using a separate wired connection, or a wireless protocol such as Bluetooth, Wi-Fi, or the like. In one aspect, the distance measuring circuit 24 comprises a camera having a view of the endodontic file 11 and processing circuitry executing image recognition software. In this aspect, the processing circuitry may calculate either or both of the distance d and the working length. In one aspect, the distance measuring circuit 24 alternatively or additionally displays one or both of the measured distance between the handle 20 and the stopper 22, and the working length, such as on a display (not shown) in the handle 20, such as an LCD, LED, plasma, or other type display.

FIG. 2 depicts an endodontic treatment system, according to one aspect of the present disclosure. An Endodontic Control Unit (ECU) 30 contains an integrated EAL system 32 and a Working Length Measurement circuit 34. As well known for EAL 32 operation, a file clip 36 clips to an endodontic file 11, and a lip clip 38 is connected to the patient's lip. This establishes an electrical circuit through the root canal of the tooth being treated, the electrical properties of which the EAL 32 monitors to detect when the tip 18 of the endodontic file 11 reaches a predetermined point within the root canal. After the EAL 32 indicates the proper depth, and the clinician slides the stopper 22 to the top of the tooth, the Working Length Measurement circuit 34 repurposes at least the file clip 36 and its wired connection, to read one of the measured distance between the handle 20 and the stopper 22, and the working length, from the distance measuring circuit 24, e.g., in the handle 20 of the file 12. The Working Length Measurement circuit 34 then displays (or otherwise outputs) the working length.

The Working Length Measurement circuit 34 may display the calculated working length directly, such as to a display on the ECU 30. In some aspects, where the ECU 30 includes magnifying optics worn by the endodontic clinician, the calculated working length is displayed by the optics such that it is easily visible to the clinician through the optics. Such display technology is known as Heads Up Display (HUD), and it is common in aviation and is also deployed in some automobiles.

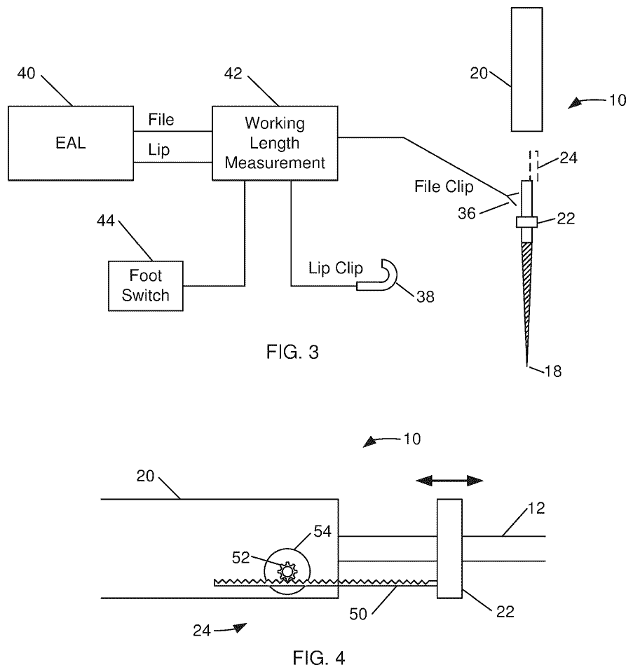

FIG. 3 depicts an endodontic treatment system, according to another aspect of the present disclosure. In this system, a conventional EAL 40 outputs a file clip lead and inputs a lip clip lead. However, a Working Length Measurement circuit 42 is interposed between these outputs and inputs at the EAL 40, and the actual file clip 36 and lip clip 38. The Working Length Measurement circuit 42 operates in two modes, selected by the clinician via, e.g., a foot switch 44 (or other suitable input). In a first mode, the Working Length Measurement circuit 42 operates in “pass-through” fashion, and simply establishes connections between the File and Lip connections to the EAL 40, and the file clip 36 and lip clip 38, respectively. This allows the EAL 40 to operate as designed, allowing the clinician to properly position the endodontic file 12 at the predetermined location in the tooth.

After sliding the stopper 22 to the top of the tooth, the clinician, via the foot switch 44, switches the Working Length Measurement circuit 42 to a second mode, in which it disconnects the EAL 40 and repurposes at least the file clip 36 and its associated connection. In the aspect depicted in FIG. 3, the Working Length Measurement circuit 42 uses the file clip 36 connection to provide power to the distance measuring circuit 24 in the handle 20 of the file 12, and to read distance data from the distance measuring circuit 24. The Working Length Measurement circuit 42 may read the actual working length from the distance measuring circuit 24, or alternatively may read, from the distance measuring circuit 24, the distance between the handle 20 and the stopper 22, and may itself calculate the working length. In either case, the Working Length Measurement circuit 42 then outputs the working length, such as via a display, or by wired or wireless connection to a different device (e.g., a laptop or tablet computer, a smartphone, or the like), to a HUD display in the clinician's optics, etc. The aspect of the present disclosure depicted in FIG. 3 is particularly advantageous in practices that already have a modern EAL 40.

The distance measuring circuit 24 may employ any distance measuring technology known in the art.

FIG. 4 depicts one aspect of the present disclosure, in which the distance measuring circuit 24 employs a rotary potentiometer or encoding wheel 54. A toothed actuating arm 50 is connected to the stopper 22. As the stopper 22 moves longitudinally along the shaft 12 of the endodontic file 10, the toothed actuating arm 50 moves longitudinally along a line parallel to the axis of the shaft 12. A gear 52 within the handle 20 engages with the toothed actuating arm 50, and moves rotationally in response to longitudinal motion of the toothed actuating arm 50. In one aspect, the gear 52 is attached to a rotary potentiometer 54 configured as a variable resistor, also known as a rheostat. The potentiometer 54 changes resistance in response to rotation of its shaft. The resulting resistance may be detected, such as by use of a Wheatstone bridge circuit (not shown), as well known in the art. This resistance is calibrated to correspond to the distance between the handle 20 and the stopper 22.

In another aspect, the toothed actuating arm 50 engages the gear 52 as described above. However, in this aspect the gear 52 is connected to an encoding wheel 54. Encoding wheels may be implemented using various technologies. An encoding wheel outputs a position signal, such as series of pulses, from which position, rotation, distance, and speed may be determined.

In one aspect, an optical encoding wheel is used, in which an array of, e.g., LEDs is oriented radially with respect to the wheel. A corresponding array of photodetectors is positioned on the opposite side. A pattern of holes is formed in concentric, circumferential tracks in the wheel. As the wheel rotates, light passing through holes in the pattern is detected by the photodetectors. The output position signal is a series of pulses from the photodetectors, from which the wheel position, rotation, and speed may be determined.

In another aspect, the encoding wheel 54 is magnetically encoded. A magnetized wheel spins over a plate of magneto-resistive sensors. The wheel causes predictable responses in the sensor, based on the strength of the magnetic field. The magnetic response is transduced to an electrical signal and processed to resolve position, direction of rotation, distance, and speed.

In yet another aspect, the encoding wheel 54 is capacitively encoded. A sinusoidal pattern of copper tracks is formed in a Printed Circuit Board (PCB) on one surface of the wheel. A high-frequency reference signal is transmitted by a fixed transmitter towards the wheel, and a stationary receiver is positioned on the opposite side of the wheel. As the encoding wheel 54 rotates, the copper pattern modulates the transmitted signal in a predictable way, and the receiver output is translated into increments of rotary motion in a position signal output by the capacitive encoding wheel 54.

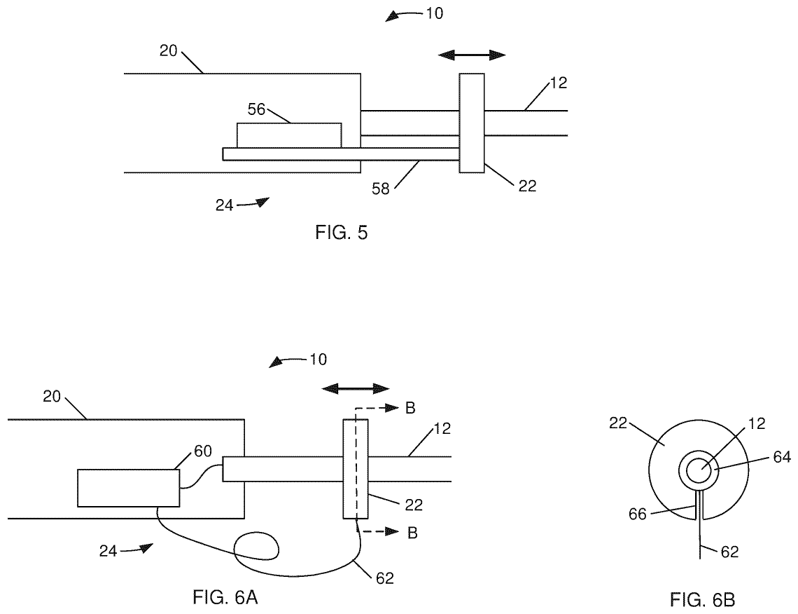

FIG. 5 depicts an aspect of the present disclosure, in which the distance measuring circuit 24 employs a linear variable resistor or linear capacitive encoder 56. An actuating arm 58 is rigidly affixed to the stopper 22. As the stopper 22 moves longitudinally along the shaft 12 of the endodontic file 10, the actuating arm 58 moves longitudinally along a line parallel to the axis of the shaft 12. In one aspect, the actuating arm 58 is attached to a linear variable resistor 56. The linear variable resistor 56 changes resistance in response to linear movement of the actuating arm 58. The resulting resistance may be detected, such as by use of a Wheatstone bridge circuit (not shown), as well known in the art. This resistance is calibrated to correspond to the distance between the handle 20 and the stopper 22.

In another aspect, a PCB is attached to the actuating arm 58, on the side facing the linear capacitive encoder 56. The PCB includes a repetitive pattern of wide copper traces. Contacts on the linear capacitive encoder 56 contact the copper traces, forming a variable capacitor as the actuating arm 58 moves with respect to the linear capacitive encoder 56. This capacitance is calibrated to correspond to the distance between the handle 20 and the stopper 22.

FIGS. 6A and 6B depict an aspect of the present disclosure, in which the distance measuring circuit 24 determines the distance between the handle 20 and the stopper 22 by sensing the resistance of the shaft 12 between these two elements. As shown in FIG. 6A, a resistance sensing circuit 60 in the handle 20 is connected to the shaft 12, and also to the stopper 22 by a wire 62. As shown in the section view of FIG. 6B, the wire 62 extends through a channel 66 in the stopper 22, which is formed of a dielectric material, such as plastic. A contact ring 64, formed of a conductive material such as copper, contacts the shaft 12. The wire 62 is connected to the contact ring 64. In this aspect, the shaft 12 is formed of a material having a known, and preferably constant, resistance per unit length, i.e., Q/mm. The resistance sensing circuit 60, which may, for example, comprise a Wheatstone bridge circuit, senses a lower resistance of the shaft 12 when the stopper 22 is closer to the handle 20, and a higher resistance when the stopper 22 is further from the handle 20. A calibration procedure quantifies the change in resistance and translates it to the length of the shaft 12 between the handle 20 and the stopper 22. As an alternative to measuring the shaft 12 resistance, a strip of material (not shown), having a known constant resistance per unit length, may be embedded in the shaft 12 along its longitudinal axis, and the resistance sensing circuit 60 measures the change in resistance of the strip to ascertain the distance between the handle 20 and the stopper 22.

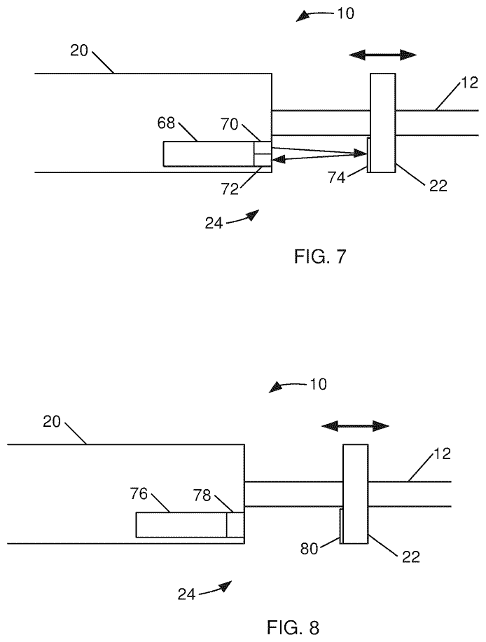

FIG. 7 depicts an aspect of the present disclosure, in which the distance measuring circuit 24 determines the distance between the handle 20 and the stopper 22 by radiated signal rangefinding. A rangefinding circuit 68 includes a transmitter 70 and receiver 72. In some aspects, a reflection plate 74 affixed to the stopper 22 optimizes reflection of the radiated signal, which may otherwise be absorbed, attenuated, scattered, or the like by the stopper 22. In some aspects, the signal transmitted may be an electromagnetic signal having any frequency, such as Radio Frequency (RF), millimeter wave, RADAR, or the like. In these aspects, the reflection plate 74 may comprise a metal piece, optionally having a polished surface facing the rangefinding circuit 68. In other aspects, the signal transmitted may be an optical signal having any frequency, such as infrared (IR), visible light, Ultraviolet (UV), or the like. In these aspects, the reflection plate 74 may comprise a mirror, such as a front-coated mirror. In some aspects, the signal transmitted may be an acoustic signal having any frequency, such as an ultrasonic signal. In these aspects, the reflection plate 74 may not be present, or may comprise any material which optimally reflects acoustic energy.

In some aspects, the rangefinding circuit 68 may calculate the distance between the handle 20 and the stopper 22 by performing “time of flight” calculations, wherein the distance is the round trip time (RTT) of the transmitted and received signal, divided by the propagation speed of the signal in the medium (e.g., air having a particular temperature and humidity).

Alternatively, the rangefinding circuit 68 may employ triangulation, wherein the signal transmitted is a laser beam, and the receiver/detector 72 comprises, e.g., an array of sensor elements, such that the precise location of the reflected beam is known. In this case, the geometry of the triangle formed by the transmitted and reflected beams is used to determine the distance between the handle 20 and the stopper 22.

As yet another alternative, the rangefinding circuit 68 may use confocal sensing, in which polychromatic (e.g., white) light is reflected off of the reflection plate 74, and the receiver 72 comprises optics that focus the received beam on a detector. Because each wavelength of light in the polychromatic beam focuses at a different distance, by sensing the wavelength (i.e., color) of light precisely focused on the detector, the path distance of the beam can be calculated.

As still another alternative, the rangefinding circuit 68 may employ interferometry, wherein a beam splitter sends one laser beam to the stopper 22 and another through a reference path (not shown) within the handle 20, and comparison of the two yields the beam path distance. As still another alternative, the rangefinding circuit 68 may employ optical coherence tomography, which is a type of interferometry that exploits the different wavelengths of polychromatic light, rather than mechanical distance of the alternate beam path.

As still another alternative, the rangefinding circuit 68 may employ conoscopic holography, wherein optical elements split a received optical beam and direct it into two optical paths, which have opposite polarizations. An optical element in one path slows the velocity of beam propagation with respect to the other path. When the beams are then combined, an interference pattern is created, which is calibrated to yield the distance between the handle 20 and the stopper 22.

FIG. 8 depicts an aspect of the present disclosure, in which the distance measuring circuit 24 determines the distance between the handle 20 and the stopper 22 by inductive sensing. An inductive distance sensor 76 includes an oscillator 78, which generates a high-frequency electromagnetic field. A metal tripping plate 80 changes the EM field in predictable ways, depending on its distance, material, and size. The change in EM field is detected by the inductive distance sensor 76, which converts it to a proportional output signal. Since the material and size of the tripping plate 80 are fixed, the system may be calibrated to yield the distance between the handle 20 and stopper 22.

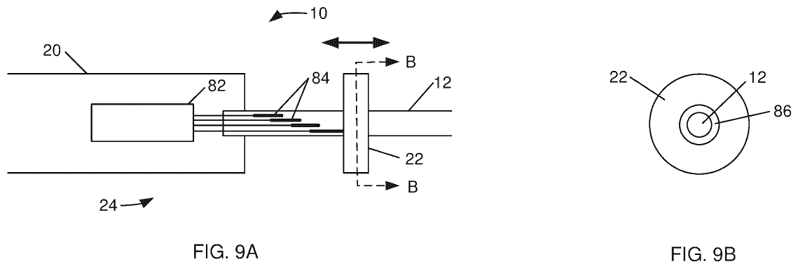

FIGS. 9A and 9B depict an aspect of the present disclosure, in which the distance measuring circuit 24 determines the distance between the handle 20 and the stopper 22 by short-circuiting conductive strips 84. A discriminator circuit 82 has separate connections to a plurality of conductive strips 84, which are embedded in the shaft 12 in a spiral pattern around the circumference of the shaft 12, as depicted in FIG. 9A. As the stopper moves along the shaft 12, a conductive ring 86, as depicted in FIG. 9B, electrically connects (i.e., short-circuits) at least two conductive strips 84. The discriminator circuit 82 determines which of the conductive strips 84 are electrically connected, and hence infers the position of the stopper. In the aspect depicted in FIG. 9A, only two conductive strips 84 are electrically connected at any time. In different aspects, the conductive strips 84 may be sized and arranged such that two, three, or more are electrically connected, depending on the position of the stopper 22. In another aspect, the conductive strips 84 may each have a different known resistance, and the discriminator circuit 82 measures the combined resistance to determine the position of the stopper 22.

The above descriptions of various aspects of the distance measuring circuit 24, and the corresponding technologies employed, are presented to provide a disclosure enabling one of ordinary skill in the art to make and use the inventive distance measuring circuit 24 in a working length measuring endodontic file 10. However, these aspects are representative only, and are not limiting. In general, the distance measuring circuit 24 may employ any technology known (or which may be devised in the future) to automatically measure the distance between a handle 20 and stopper 22 of the endodontic file 11.

In some aspects, when disposed within the handle 20 of an endodontic file 11, the distance measuring circuit 24 may be powered by energy harvested from the file clip 36 and its associated signal wire. In one aspect, current supplied to the file clip 36 by the EAL may be tapped to charge a capacitor in the handle 20, which subsequently powers the distance measuring circuit 24. In another aspect, the handle 20 may include a battery (not shown), which may be rechargeable. In one aspect, the rechargeable battery may include a charging circuit that receives energy via inductive coupling, avoiding the need to plug the working length measuring endodontic file 11 into a charger.

In one aspect, the distance measuring circuit 24 outputs the measured distance between the handle 20 and the stopper 22. In another aspect, the distance measuring circuit 24 calculates the working length from the known length of the shaft 12 and the width of the stopper 22, and outputs the working length. In one aspect, the distance measuring circuit 24 outputs one of the measured distance between the handle 20 and the stopper 22, and the working length, via the wire connected to the file clip 36, e.g., by using any modulation or signal transfer protocol. In one aspect, the distance measuring circuit 24 outputs one of the measured distance between the handle 20 and the stopper 22, and the working length, via a separate wired connection (not shown), or via any wireless communication protocol, such as Bluetooth, Wi-Fi, or the like.

In the above-described aspects of the present disclosure, the working length measuring endodontic file system 10 includes a distance measuring circuit 24 disposed within the handle 20 of the endodontic file 11. According to other aspects, depicted in FIGS. 10 and 11, the working length measuring endodontic file system 10 comprises a file/camera/software system, in which the distance measuring circuit 24 is not disposed within the handle 20 of the endodontic file 11, but rather comprises a camera 25 and image recognition software. The camera 25 may comprise any appropriate visible light camera-either still camera or video; greyscale or color; etc. The camera 25 may include lighting (not shown) to illuminate the endodontic file 11 as necessary to obtain high quality images. The camera 25 is preferably positioned a fixed distance from the endodontic file 11, such as in a bracket or jig.

FIG. 10 corresponds generally to FIG. 2, wherein a Working Length Measurement circuit 34 is integrated with the EAL 32 in an Endodontic Control Unit 30. Similarly, FIG. 11 corresponds generally to FIG. 3, and depicts an aspect where the Working Length Measurement circuit 42 is separate from the EAL 40. In both aspects, the Working Length Measurement circuit 34, 40 receives the output of the camera 25.

Image recognition software-which may be executed in the camera 25, in the Working Length Measurement circuit 34, 42, or elsewhere-recognizes and classifies at least the handle 20 and the stopper 22 of the endodontic file. Image recognition is well known in the art, and indeed has proliferated as increasingly sophisticated Machine Learning (ML) models and training methodologies have evolved, making the technology appropriate and available for a wide variety of use cases. Image recognition technology has its highest success rates in applications where the objects desired to be recognized/classified have consistent, known characteristics (shape, size, color, texture), and their positions within an image frame are constrained to known ranges and/or relationships. Both features are present in the recognition of an endodontic file handle 20 and stopper 22 in use in endodontic procedures—the objects' characteristics span a limited range, and their relative sizes and positions are also within a narrow range. Accordingly, image recognition software can easily be trained to recognize an endodontic file handle 20 and stopper 22 with very high accuracy.

In one aspect, software uses the known thickness of the stopper 22 to scale the image, for example to adjust for differences in the relative position of the camera. Software calculates the distance d, in the image, between the end of the handle 20 and the near end of the stopper 22. As one non-limiting example, the software may calculate the fractional number of times the thickness of the stopper 22 fits into the space between the handle 20 and stopper 22, and then multiply this number by the known thickness of the stopper 22. The measurement may be made in a reference scale (e.g., mm), or may be made in a local scale (e.g., pixels), and then converted to the reference scale. Calculation of the working length is straightforward, using equation (1) above.

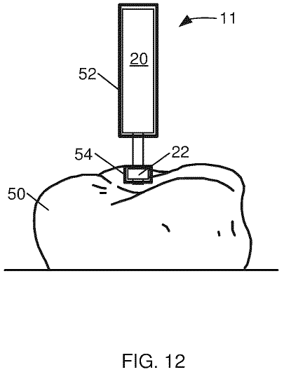

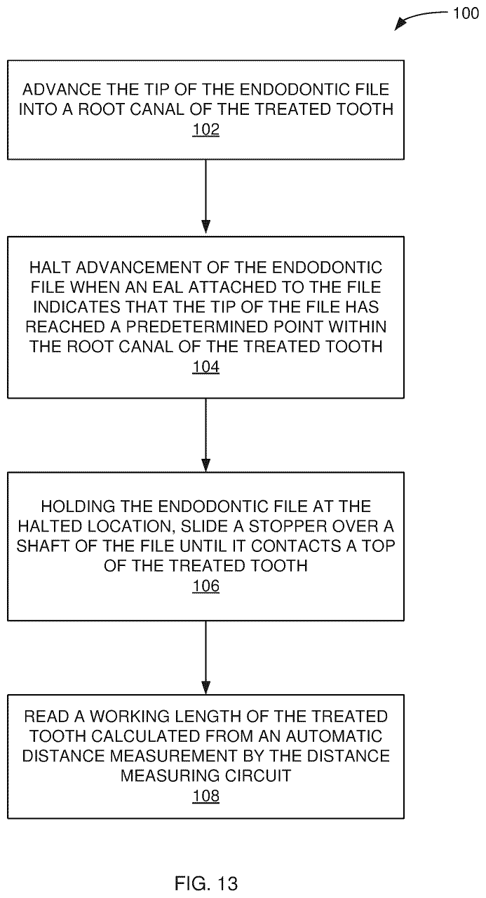

FIG. 12 represents an image captured by the camera 25 and processed by image recognition software according to an aspect of the present disclosure. An endodontic file 11 is inserted into a tooth 50, and the stopper 22 positioned at the surface of the tooth 50. The image recognition software indicates recognition of the handle 20 by the bounding box 52, and of the stopper 22 by the bounding box 54. The software then calculates a distance d between these two objects. In the case represented by FIG. 12, the stopper was 1.5 mm thick, and the shaft 12 of the file 11 was 25 mm long. The software calculated a distance d between the handle 20 and stopper 22 of 5.326 mm. By equation (1) above, then, the working length in this example is wl=25−1.5−5.326=18.174 mm.

Considering the sophistication of modern image recognition software, the simple task of recognizing two known, simple shapes, each of a known size and placed within a known, limited distance range from each other, is easily accomplished with high accuracy. Similarly, the task of calculating a distance between two recognized and classified objects, is well within the scope of even basic image recognition and manipulation software. As one non-limiting example, the software FP-AI-VISION1, available from STMicroelectronics of Geneva, Switzerland, is a suitable choice. Additionally, processing circuitry for executing the image recognition and measuring software need not be particularly large, fast, or sophisticated, considering the state of the computing arts. As one non-limiting example, the entire functionality of the Working Length Measurement circuit 32, 42, can be implemented using processor such as the STM32 family, also available from STMicroelectronics.

Although described as alternatives herein, in one aspect, a working length measuring endodontic file system 10 includes two (or more) distance measuring circuits 24. For example, any one (or more) of the distance measuring circuits 24 described herein may be disposed in the handle of an endodontic file 11, and additionally a camera 25 and image recognition software may be utilized. The two (or more) distance measuring circuits 24 may provide redundancy in automatically measuring the distance d between the handle 20 and the stopper 22, with one being usable if the other malfunctions or becomes inoperative. Additionally, each distance measuring circuit 24 may provide a “sanity check” on operation of the other distance measuring circuit(s) 24. In some aspects, the different distances di measured by each of n distance measuring circuits 24 (i=1, 2, . . . , n) may be averaged together to calculate the working length.

In any aspect described herein, the distance measuring circuit 24 and/or Working Length Measurement circuit 32, 43 may be implemented by, and/or may include, any functional means, modules, units, or circuitry. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. In aspects that employ memory, the memory stores program code that, when executed by the one or more processors, carries out the techniques described herein.

FIG. 12 depicts the steps in a method 100 of obtaining a working length for a tooth undergoing endodontic treatment. The endodontic treatment is performed using a working length measuring endodontic file system 10. As depicted in FIG. 1, the working length measuring endodontic file system 10 includes an endodontic file 11 and distance measuring circuit 24. The endodontic file 11 has a generally cylindrical shaft 12, at least part of which tapers towards a tip 18, and a handle 20 connected to the shaft 12 opposite the tip 18. An annular stopper 22 is disposed around the shaft 12, and is moveable at least part of the way between the handle 20 and tip 18 along a longitudinal axis of the shaft 12. The distance measuring circuit 24 may be disposed within the handle 20, or alternatively may comprise a separate camera 25 and image recognition software. In either case, the distance measuring circuit 24 is configured to measure a distance d between the handle 20 and the stopper 22. Referring again to FIG. 12, the tip 18 of the working length measuring endodontic file 11 is advanced into a root canal of the treated tooth (block 102). Advancement of the endodontic file 11 is halted when an Electronic Apex Locator (EAL) 32, 40 attached to the file indicates that the tip 18 of the file 11 reached a predetermined point within the root canal of the treated tooth (block 104). Holding the endodontic file 11 at the halted location, a stopper 22 is slid over a shaft 12 of the file 11 until it contacts a top of the treated tooth (block 106). A working length of the treated tooth, calculated from an automatic distance measurement by the distance measuring circuit 24, is read (block 108). The working length may be calculated and output by the distance measuring circuit 24. Alternatively, the distance measuring circuit 24 may output the measured distance between the handle 20 and the stopper 22, with the working length being calculated and displayed externally, such as by a Working Length Measurement circuit 34, 42.

Aspects of the present disclosure present numerous advantages over the prior art. By automating the measurement of the working length, significant error due to human factors may be avoided, resulting in more accurate measurement and hence a higher success rate for endodontic treatments. Furthermore, by automating the measurement of the working length, the “flow” of the endodontic treatment is not interrupted, making the treatment faster and more efficient, as well as more accurate.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the aspects disclosed herein may be applied to any other aspect, wherever appropriate. Likewise, any advantage of any of the aspects may apply to any other aspects, and vice versa. Other objectives, features, and advantages of the enclosed aspects will be apparent from the description. As used herein, the term “configured to” means set up, organized, adapted, or arranged to operate in a particular way; the term is synonymous with “designed to.”

Some of the aspects contemplated herein are described more fully with reference to the accompanying drawings. Other aspects, however, are contained within the scope of the subject matter disclosed herein. The disclosed subject matter should not be construed as limited to only the aspects set forth herein; rather, these aspects are provided by way of example to convey the scope of the subject matter to those skilled in the art.

1. A working length measuring endodontic file system, comprising:
an endodontic file comprising
a generally cylindrical shaft, at least part of which tapers towards a tip;
a handle connected to the shaft opposite the tip; and
an annular stopper disposed around the shaft, and moveable at least part of the way between the handle and tip along a longitudinal axis of the shaft; and
a distance measuring circuit configured to measure a distance between the handle and the stopper.

2. The endodontic file system of claim 1 wherein the distance measuring circuit is disposed within the handle of the endodontic file.

3. The endodontic file system of claim 1 wherein the distance measuring circuit comprises a camera having a view of the endodontic file, and image recognition software configured to:
recognize at least the handle and stopper of the file; and
calculate a distance between the handle and the stopper.

4. The endodontic file system of claim 1, wherein the distance measuring circuit is further configured to output the measured distance.

5. The endodontic file system of claim 1, wherein the distance measuring circuit is further configured to:
calculate a working length between an end of the stopper opposite the handle, and the tip; and
output the working length.

6. The endodontic file system of claim 1 wherein a working length measurement circuit is configured to communicate with the distance measuring circuit and to output a working length between the endodontic file stopper and tip of the shaft.

7. The endodontic file system of claim 6 wherein the working length measurement circuit is integrated with an Electronic Apex Locator configured to alert a clinician when the tip of the shaft is at a predetermined location within the root canal of a tooth.

8. The endodontic file system of claim 6 wherein the working length measurement circuit is interposed between an Electronic Apex Locator configured to alert a clinician when the tip of the shaft is at a predetermined location within the root canal of a tooth, and the endodontic file.

9. The endodontic file system of claim 2, wherein the distance measuring circuit comprises:
an actuating arm rigidly affixed to the stopper and extending into the handle; and
a component that alters an electrical property or outputs a position signal in response to the position of the actuating arm.

10. The endodontic file system of claim 2 wherein the distance measuring circuit comprises:
a resistance measuring component disposed within the handle and connected to the end of the shaft opposite the tip;
a conductive contact ring disposed within the stopper and in contact with the shaft; and
a wire connecting the conductive contact ring with the resistance measuring component;
whereby the resistance measuring component measures the resistance of the portion of the shaft between the end and the contact ring.

11. The endodontic file system of claim 2 wherein the distance measuring circuit uses radiated emission rangefinding, and comprises:
a radiated signal transmitter disposed in the handle and configured to transmit a signal to the stopper;
a radiated signal receiver disposed in the handle and configured to receive the transmitted signal reflected from the stopper;
and a rangefinding circuit disposed in the handle and configured to measure A distance between the handle and the stopper in response to the received signal.

12. The endodontic file system of claim 2 wherein the distance measuring circuit uses inductive sensing, and comprises:
an oscillator disposed in the handle and configured to generate a high-frequency electromagnetic field;
a metal tripping plate attached to the stopper; and
a control circuit disposed in the handle and configured to measure a distance between the handle and the stopper in response to changes in the electromagnetic field due to the position of the metal tripping plate.

13. The endodontic file system of claim 2 wherein the distance measuring circuit comprises:
a plurality of conductive strips embedded in a spiral pattern around the circumference of the shaft;
a conductive ring disposed within the stopper and in contact two or more conductive strips at any position along the shaft; and
a discriminator circuit disposed in the handle and connected to each conductive strip, the discriminator circuit configured to determine which conductive strips are electrically connected by the conductive ring.

14. A method of obtaining a working length for a tooth undergoing endodontic treatment, using a working length measuring endodontic file system comprising an endodontic file comprising a generally cylindrical shaft, at least part of which tapers towards a tip, a handle connected to the shaft opposite the tip, an annular stopper disposed around the shaft, and moveable at least part of the way between the handle and tip along a longitudinal axis of the shaft, and a distance measuring circuit configured to measure a distance between the handle and the stopper, the method comprising:
advancing the tip of the endodontic file into a root canal of the treated tooth;
halting advancement of the endodontic file when an Electronic Apex Locator attached to the file indicates that the tip of the file has reached a predetermined point within the root canal of the treated tooth;
holding the endodontic file at the halted location, sliding a stopper over a shaft of the file until it contacts a top of the treated tooth; and
reading a working length of the treated tooth calculated from an automatic distance measurement by the distance measuring circuit.

15. A non-transitory, machine-readable medium storing instructions for recognizing parts of an endodontic file comprising a generally cylindrical shaft, at least part of which tapers towards a tip, a handle connected to the shaft opposite the tip, an annular stopper disposed around the shaft, and moveable at least part of the way between the handle and tip along a longitudinal axis of the shaft, the instructions, when executed by processing circuitry, operative to cause the processing circuitry to:
recognize at least the handle and the stopper of the file; and
calculate a distance between the handle and the stopper.
